(19) United States
(12) Patent Application Publication
(10) Pub. No.: US 2021/0354659 A1
(43) Pub. Date: Nov. 18, 2021

(54) AUTOMOBILE REMOTE CONTROL POWER FAILURE ANTI-THEFT DEVICE

(71) Applicant: SHENZHEN LINKE INNOVATION TECHNOLOGY CO., LTD., HENZHEN CITY, GUANGDONG (CN)

(72) Inventor: JIANLIN LIU, SHENZHEN CITY, GUANGDONG PROVINCE (CN)

(21) Appl. No.: 16/623,005

(22) PCT Filed: Mar. 20, 2019
(86) PCT No.: PCT/CN2019/078790

§ 371 Date: Dec. 16, 2019

(51) Int. Cl. B60R 25/045; B60R 25/40; H01H 51/06; F02N 11/08

(52) U.S. Cl. CPC B60R 25/045; B60R 25/403; B60R 2025/0405; F02N 11/087; H01H 51/065

(57) ABSTRACT

An automobile remote control power failure anti-theft device is provided, which relates to the technical field of automobiles and comprises: a control switch mounted on an automobile and configured to control on/off between an automobile circuit and an automobile power source; a remote switch connected to the automobile power source and the control switch for receiving an external control signal and controlling the on/off of the control switch according to the received signal; and an external controller disposed outside the automobile and wirelessly connected to the remote switch for facilitating carrying and controlling the remote switch to user. The above technical solution can not only remotely control on/off between the automobile circuit and the automobile power source, but also prevent the automobile from being stolen, and has the advantages of convenient on/off control of the automobile circuit, good control effect and good anti-theft effect.

### FIELD OF THE DISCLOSURE

The present disclosure relates to the technical field of automobiles, in particular to an automobile remote control power failure anti-theft device.

### BACKGROUND OF THE DISCLOSURE

When the automobile is placed for a long time, the automobile's quiescent current may cause the automobile battery to lose power and cannot start the engine. The existing automobiles are equipped with electromagnetic switches between the automobile battery and the automobile circuit, and the electromagnetic switch is used to control the on/off between the automobile circuit and the automobile battery.

However, in use, after the user parks the automobile, the user needs to open the hood by oneself, and manually controls the on/off of the electromagnetic switch, thereby disconnecting the path between the automobile circuit and the automobile battery to protect the automobile battery. The arrangement of automobile circuit power failure device thus requires the user to manually power off each time whenever the automobile is parked, and the power failure process is very troublesome.

### SUMMARY OF THE DISCLOSURE

The purpose of the present disclosure is to provide an automobile remote control power failure anti-theft device, which can not only remotely control the on/off between the automobile circuit and the automobile power source, but also prevent the automobile from being stolen, and has the advantages of convenient on/off control of the automobile circuit, good control effect and good anti-theft effect.

In order to achieve the above object, the technical solution adopted by the present disclosure is to provide an automobile remote control power failure anti-theft device, comprising: a control switch mounted on an automobile and configured to control on/off between an automobile circuit and an automobile power source; a remote switch connected to the automobile power source and connected to the control switch for receiving an external control signal and controlling the on/off of the control switch according to the received signal; and an external controller disposed outside the automobile and wirelessly connected to the remote switch for facilitating carrying and controlling the on/off of the remote switch to user.

The control switch is an electromagnetic switch, and the remote switch is a wireless remote control switch.

The electromagnetic switch is provided with a coil wiring terminal and a switch wiring terminal, and the wireless remote control switch is provided with a power supply wiring terminal and an on/off wiring terminal.

Two coil wiring terminals are provided, which are a first coil wiring terminal and a second coil wiring terminal. Two switch wiring terminals are provided, which are a first switch wiring terminal and a second switch wiring terminal. Two on/off wiring terminals are provided, which are a first on/off wiring terminal and a second on/off wiring terminal. Three power supply wiring terminals are provided, which are a first power supply wiring terminal, a second power supply wiring terminal, and a third power supply wiring terminal. When wiring, the first switch wiring terminal is electrically connected to an anode of the automobile power source, and the second switch wiring terminal is electrically connected to the automobile circuit; the first coil wiring terminal is electrically connected to the anode of the automobile power source, the second coil wiring terminal is electrically connected to the second on/off wiring terminal, and the first on/off wiring terminal is electrically connected to the cathode of the automobile power source; and the first power supply wiring terminal is electrically connected to the anode of the automobile power source, and the third power supply wiring terminal is electrically connected to a cathode of the automobile power source.

The wireless connection between the external controller and the remote switch is an infrared wireless connection or a radio wave wireless connection.

After adopting the above technical solution, the beneficial effects of the utility model are as follows.

By adding a control switch between the automobile circuit and the automobile power source, and controlling the on/off of the control switch through the remote switch and the external controller, the on/off between the automobile circuit and the automobile power source can be achieved, and it can be avoided that when the circuit of the existing automobiles is disconnected, the user needs to open the hood of the automobile after the automobile is parked, and disconnects the connection between the automobile circuit and the automobile power source by manually controlling the electromagnetic control switch, thereby ensuring the convenience of disconnecting the connection between the automobile circuit and the automobile power source.

The remote switch requires very little power during operation, but the electromagnetic switch requires a very large amount of power. Therefore, controlling the on/off of the electromagnetic switch through the remote switch and the external controller can save the power of the automobile power source, and the connection between the automobile power source and the automobile circuit is disconnected by the external controller, so that the automobile is difficult to start between the disconnection of the automobile power source and the automobile circuit, thereby providing a good anti-theft effect on the automobile.

### BRIEF DESCRIPTION OF THE DRAWINGS

In order to more clearly illustrate the embodiments of the present disclosure or the technical solutions in the prior art, the drawings to be used in the embodiments or the description of the prior art will be briefly described below. Obviously, the drawings in the following description are only some embodiments of the present disclosure, and other drawings can be obtained according to the drawings without any creative labor for those skilled in the art.

FIG. 1 is a schematic view of the overall structure of the present disclosure.

Reference numeral: 1. control switch; 2. remote switch; 3. external controller; 4. automobile power source; 5. automobile circuit; 6. first coil wiring terminal; 7. second coil wiring terminal; 8. first switch wiring terminal; 9. second switch wiring terminal; 10. first on/off wiring terminal; 11. second on/off wiring terminal; 12. first power supply wiring terminal; 13. second power supply wiring terminal; 14. third power supply wiring terminal.

### DETAILED DESCRIPTION OF THE EXEMPLARY EMBODIMENTS

The present disclosure will be further described in detail below with reference to the accompanying drawings.

The specific embodiments are merely illustrative of the present disclosure, and are not intended to limit the present invention. Those skilled in the art can make modifications that do not contribute to the present embodiment as needed after reading the present specification, but only in the present application. The scope of the new claims is protected by patent law.

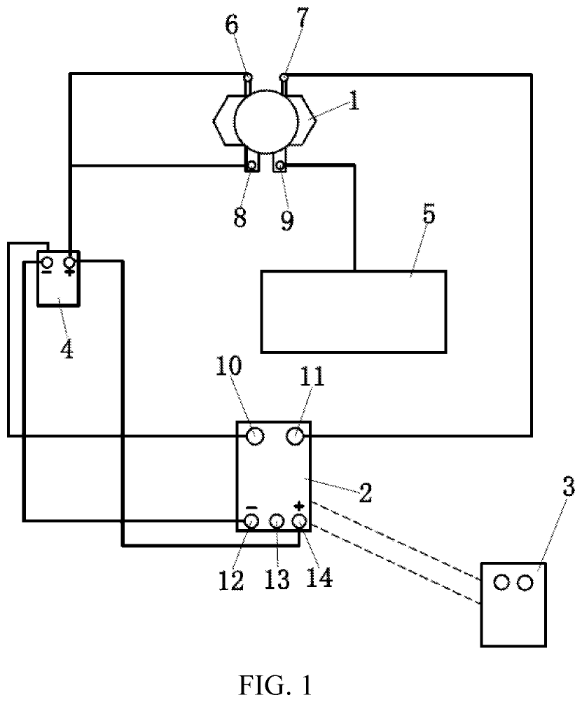

The embodiment relates to an automobile remote control power failure anti-theft device, as shown in FIG. 1, comprising: a control switch 1, a remote switch 2, and an external controller 3.

The control switch 1 is mounted on an automobile and configured to control the on/off between an automobile circuit 5 and an automobile power source 4. The remote switch 2 is connected to the automobile power source 4 and connected to the control switch 2 for receiving an external control signal and controlling the on/off of the control switch 2 according to the received signal. The external controller 3 is disposed outside the automobile and wirelessly connected to the remote switch 2 for facilitating carrying and controlling the on/off of the remote switch 2 to user.

As shown in FIG. 1, in the embodiment, the control switch 1 is an electromagnetic switch, and the remote switch 2 is a wireless remote control switch. The electromagnetic switch is provided with a coil wiring terminal and a switch wiring terminal, and the wireless remote control switch is provided with a power supply wiring terminal and an on/off wiring terminal. The wireless connection between the external controller 3 and the remote switch 2 is an infrared wireless connection or a radio wave wireless connection.

Two coil wiring terminals are provided, which are a first coil wiring terminal 6 and a second coil wiring terminal 7. Two switch wiring terminals are provided, which are a first switch wiring terminal 8 and a second switch wiring terminal 9. Two on/off wiring terminals are provided, which are a first on/off wiring terminal 10 and a second on/off wiring terminal 11. Three power supply wiring terminals are provided, which are a first power supply wiring terminal 12, a second power supply wiring terminal 13, and a third power supply wiring terminal 14. When wiring, the first switch wiring terminal 8 is electrically connected to the anode of the automobile power source 4, and the second switch wiring terminal 9 is electrically connected to the automobile circuit 5. The first coil wiring terminal 6 is electrically connected to the anode of the automobile power source 4, the second coil wiring terminal 7 is electrically connected to the second on/off wiring terminal 11, and the first on/off wiring terminal 10 is electrically connected to the cathode of the automobile power source 4. The first power supply wiring terminal 12 is electrically connected to the anode of the automobile power source 4, and the third power supply wiring terminal 14 is electrically connected to the cathode of the automobile power source 4.

In other embodiments, the control switch 1 can also be an electromagnetic relay, a knife switch, etc., and the remote control switch 1 can also be a remote control switch, a Bluetooth wireless switch, or the like.

The working principle of this embodiment is substantially as follows. After the control switch 1, the remote switch 2, the automobile power source 4 and the automobile circuit 5 are connected, when the automobile needs to be started, the command is input through the external controller 3, and the external controller 3 converts the command into a wireless signal for transmission, then the receiving module on the remote switch 2 receives the wireless signal, and analyzes the received command to control the connection between the first on/off wiring terminal 10 and the second on/off wiring terminal 11, so that the coil on the electromagnetic switch is energized, and the first switch wiring terminal 8 and the second switch wiring terminal 9 on the electromagnetic switch are controlled to be connected by the Loren magnetic generated by the coil, thereby controlling the automobile power source 4 to connect the automobile circuit 5. After the automobile is parked, a disconnection command is input to the external controller 3, and the external controller 3 converts the disconnection command into a wireless signal for transmission, then the receiving module on the remote switch 2 receives the wireless signal, and analyzes the received command to control the first on/off wiring terminal 10 to be disconnected from the second on/off wiring terminal 11 so as to disconnect the circuit for energizing the coil in the electromagnetic switch, and the first switch wiring terminal 8 and the second switch wiring terminal 9 on the electromagnetic switch are thus disconnected, thereby avoiding that when the circuit of the existing automobiles is disconnected, the user needs to open the hood of the automobile after the automobile is parked, and disconnects the connection between the automobile circuit 5 and the automobile power source 4 by manually controlling the electromagnetic control switch 1. Therefore, the automobile remote control power failure anti-theft device provided by the present disclosure can not only remotely control the on/off between the automobile circuit 5 and the automobile power source 4, but also can prevent the automobile from being stolen, and has the advantages of convenient on/off control of the automobile circuit 5, good control effect and good anti-theft effect.

The above is only for explaining the technical solutions of the present disclosure and not limiting, and other modifications or equivalents to the technical solutions of the present disclosure made by those skilled in the art without departing from the spirit and scope of the technical solutions of the present disclosure are intended to be covered by the scope of the claims of the present disclosure.

What is claimed is:

1. An automobile remote control power failure anti-theft device, comprising: a control switch (1) mounted on an automobile and configured to control on/off between an automobile circuit (5) and an automobile power source (4);
a remote switch (2) connected to the automobile power source (4) and connected to the control switch (1) for receiving an external control signal and controlling the on/off of the control switch (1) according to the received signal; and
an external controller (3) disposed outside the automobile and wirelessly connected to the remote switch (2) for facilitating carrying and controlling the on/off of the remote switch (2) to user.

2. The automobile remote control power failure anti-theft device according to claim 1, wherein the control switch (1) is an electromagnetic switch, and the remote switch (2) is a wireless remote control switch.

3. The automobile remote control power failure anti-theft device according to claim 2, wherein the electromagnetic switch is provided with a coil wiring terminal and a switch wiring terminal, and the wireless remote control switch is provided with a power supply wiring terminal and an on/off wiring terminal.

4. The automobile remote control power failure anti-theft device according to claim 3, wherein two coil wiring terminals are provided, which are a first coil wiring terminal (6) and a second coil wiring terminal (7);
two switch wiring terminals are provided, which are a first switch wiring terminal (8) and a second switch wiring terminal (9);
two on/off wiring terminals are provided, which are a first on/off wiring terminal (10) and a second on/off wiring terminal (11);
three power supply wiring terminals are provided, which are a first power supply wiring terminal (12), a second power supply wiring terminal (13), and a third power supply wiring terminal (14);
when wiring, the first switch wiring terminal (8) is electrically connected to an anode of the automobile power source (4), and the second switch wiring terminal (9) is electrically connected to the automobile circuit (5);
the first coil wiring terminal (6) is electrically connected to the anode of the automobile power source (4), the second coil wiring terminal (7) is electrically connected to the second on/off wiring terminal (11), and the first on/off wiring terminal (10) is electrically connected to a cathode of the automobile power source (4); and
the first power supply wiring terminal (12) is electrically connected to the anode of the automobile power source (4), and the third power supply wiring terminal (14) is electrically connected to the cathode of the automobile power source (4).

5. The automobile remote control power failure anti-theft device according to claim 3, wherein the wireless connection between the external controller (3) and the remote switch (2) is an infrared wireless connection or a radio wave wireless connection.
